(19) United States
(12) Patent Application Publication
(10) Pub. No.: US 2006/0219825 A1
(43) Pub. Date: Oct. 5, 2006

(54) High pressure fluid/particle jet mixtures utilizing metallic particles

(75) Inventors: Steven A. Rohring, Buffalo, NY (US); Benjamin F. Dorfman, San Francisco, CA (US)

Correspondence Address: Vincent G. Lotempio, PO BOX 820, East Amherst, NY, 14051, US

(73) Assignee: United Materials International

(21) Appl. No.: 11/399,564

(22) Filed: Apr. 5, 2006

Related U.S. Application Data
(60) Provisional application No. 60/668,453, filed on Apr. 5, 2005.

(51) Int. Cl. B02C 19/06

(52) U.S. Cl. 241/5

(57) ABSTRACT

A method for processing metals and materials consisting predominantly of metallic elements through the use of a multifunctional high-pressure particle jet that produces powders, cuts subject materials and performs surface treatment on particles and subject materials. The process comprises entraining metallic particles into a pressurized stream to form a particle jet, impacting the particle jet into a metallic subject material and then regulating or tuning the incident angle of impact relative to the subject matter, the pressure of the pressurized stream in a specific range and the physical and chemical properties of selected materials to conduct cutting, surface treatment of material or production of smaller particles of material.

This application claims priority of the United States Provisional Patent Application to Benjamin F. Dorfman and Steven A. Rohring, serial number 60/668453 for METHODS FOR IMPROVING ABRASIVE JET TECHNOLOGY AND APPARATUS FOR THE SAME, filed on Apr. 5, 2005.

### BACKGROUND OF THE INVENTION

The invention relates to the field of high-pressure Particle Jet (also sometimes known as ‘Abrasive Waterjet’ or ‘Abrasivejet’) technology used in material treatment and cutting, and more specifically, improvements upon conventional Particle Jet technology in the areas of non-conventional metallic abrasive particles; micro and nano powder production, metallic particle restructuring, cutting of subject materials and surface treatment of subject materials.

Conventional Particle Jet technology utilizing an Abrasive Water Jet is used to cut a variety of materials but is found to be highly inefficient in the use of energy and resources mainly due to equipment design limitations that incorporate use of garnet as the abrasive. Conventional Particle Jet is also currently limited to perform one viable function at a time such as thru cutting of material or surface removal of material as there are not any Particle Jet systems currently producing useful byproducts simultaneously with the initial function of material removal. This is primarily due to the widespread acceptance of garnet as the preferred abrasive for almost all conventional applications.

A high-pressure pump is utilized to generate fluid pressure, usually above 30,000 psi, and preferably with water or water with additives as the liquid medium. The pressurized liquid is then transported at high velocities through tubing to a cutting head that mainly consists of an orifice to deliver the liquid, an abrasive feed tube, a mixing chamber where the liquid and abrasive are mixed, and a nozzle (sometimes called a focusing tube or a mixing tube) that finally directs the Particle Jet stream onto the subject material that is to be removed.

Currently, there are not any significant differences between any cutting head devices or techniques of conventional Particle Jet equipment manufacturers, as generally all orifice, nozzle, and abrasive materials incorporated are the same for each manufacturer. Orifices are usually made from hard materials such as diamond or sapphire that generally produce a non-laminar jet. Nozzles are mostly made from a very hard tungsten carbide. Conventional Particle Jet equipment manufacturers also have similar cutting head designs with non-significant variations between each design. These cutting head designs have been widely demonstrated to cut at speeds within 30% of each other with similar surface finishes in comparative testing when equal parameters were used.

A more important similarity, as well as deficiency, of conventional Abrasive Water Jet technology is the widespread use of garnet abrasives over all other abrasives. Garnet is widely used because of its initial low cost and ability to cut a wide range of subject materials; however, it is widely used mainly because of its lower overall costs when compared to other conventional abrasives.

Conventional Particle Jet technology does not effectively use abrasives other than garnet due to numerous factors such as higher initial costs of most other hard abrasives compared to garnet and the inability of other hard abrasives to cut significantly faster than garnet. These factors generally result in higher overall costs of abrasive consumption after considering the final amount of material cut. There is also the limitation of conventional Particle Jet cutting head technology preventing use of harder abrasives than garnet because of the increased costs of accelerated nozzle wear created by these harder abrasives.

The similarities of conventional cutting head designs' use of only one type of nozzle material, primary use of only one abrasive medium, and use of only two types of orifice materials, mainly produce a common limitation of poor overall energy efficiency.

Garnet is conventionally used because it does not wear the nozzles out significantly even with the non-laminar jet produced a conventional orifice as shown in FIG. 1 of U.S. Pat. No. 5,184,434. Garnet also has a low initial cost and it is effective in cutting a wide range of materials without significantly wearing the nozzle while using the standard 3:1 nozzle to orifice size ratio. These factors allow for a lower overall cost compared to other abrasives and allow garnet to be the single abrasive medium used for almost all Particle Jet applications. However, there are many reasons why garnet is not the optimum abrasive available when considering the complete Particle Jet system, recycling and the ability to perform two or more processes in one operation.

One reason is that garnet is not the optimum abrasive is because it is not recyclable effectively. It is widely accepted that only 30% to 50% of larger garnet particles can be reclaimed for reuse after a single cutting operation as most of the garnet particles are reduced in size from fracturing upon impact and made less effective for further cutting of subject materials. Current recycling processes of garnet generally add unused larger particles to the reclaimed particles in order to keep cutting speeds at an acceptable level.

Another disadvantage is that very hard materials such as tungsten carbide and other hard ceramics are generally not cut with Particle Jet technology because of the very low cutting speed ability of garnet to cut these materials. A further disadvantage of single-abrasive, specifically, garnet-based Particle Jet technology, is undesirable mixing of the resulted products. Use of abrasive particles, such as garnet, mixed with particles of the removed subject materials usually do not allow economical or practical separation of both said products and both are generally considered as waste particles. Current recycling technology does not separate different particle materials but mainly separates different particles sizes. Larger particles are generally garnet particles that have not fractured significantly while the smaller particles are generally a mixture of subject materials and fractured garnet that are not separated further because of cost restrictions.

In another area, large amounts of energy are consumed to obtain certain physical properties, shapes, and sizes of particles by conventional mechanical pressing such as with hydraulic presses, ball milling, or advanced processing such as laser atomization, in order to make certain metallic nano or micro scale powders. The market prices of these powders can reach several hundred dollars per pound using these and other methods.

### SUMMARY OF THE INVENTION

The general concept of the proposed invention is the use of non-conventional abrasives and optimized cutting head configurations both designed for improvements to traditional Particle Jet applications along with creating new areas of technology currently not associated with Particle Jet. Hence, in accordance with the present invention, garnet may be only suited to cut certain materials effectively such as glass, stone, softer ceramic materials, certain plastics and composites, but not suited for most materials as it is today.

It is proposed that subject materials are processed more efficiently through optimization of the abrasive material in relation to the said subject material, resulting with: Reduced overall costs of the Particle Jet technique for cutting or other material removing technology; Improvements to the Particle Jet technique generating increased cutting speeds, better tolerances, and higher resulting surface finish quality of subject materials; Creation of several novel manufacturing technologies based on the Particle Jet technique as disclosed herein.

As the result of extensive research and tests, the authors of the present invention had revealed the threshold phenomena in Particle Jet interaction with various subject materials. It was found that the dependence of cutting speed of any material is a nonlinear function of hardness and other properties of abrasive materials in relation to their impact onto subject materials.

Furthermore, such nonlinear dependencies are very similar for different types of subject materials as demonstrated by empirical testing. Such similarities were realized through comparison of ratios between the hardness of abrasive particles to the hardness of subject materials. This ratio is referred herein as the relative hardness.

Specifically, at a certain narrow range of relative hardness, typically between 1.0 to 2.0, and most commonly in vicinity of relative hardness 1.5, the cutting speed experiences a dramatic increase up to, or even exceeding, an order of magnitude. This threshold phenomena is especially strong in the case of metallic subject materials, including pure metals, and, particularly important for commercial applications, steels and alloys of any kind.

More specifically, as it is quantitatively disclosed, prior to threshold, e.g. at relatively low hardness of abrasive material, cutting speed of metals in general, and steels in particular, is very low, while beyond of threshold, e.g. at relatively high hardness of abrasive material, cutting speed is high and only weakly depends on further increase of the hardness of abrasive material.

This discovery which was not known by the prior art and could not be anticipated based on priory known empiric data, is of crucial importance for the present invention because it allows the following: Optimized selection of abrasive materials correspondingly to specific subject material and specific technical task; Usage of the same abrasive material or material of similar chemical composition as the subject material, such as abrasive made of the hardened steel to cut similar annealed steel, etc.; Realization of the Particle Jet cutting technology producing a set of useful products, such as valuable micro- and nano-powders while preventing mutual contamination of abrasive and subject materials and virtually excluding waste; Usage of the Particle Jet to carry softer material than the subject material in order to realize various pre-designed surface engineering of subject material, or particles, or both while reducing the cutting effect and minimizing the material removing effect.

It should be pointed that while the same value of said threshold is usually well defined for different abrasive and subject materials, the hardness alone is not always sufficient to define the cutting speed beyond or prior to threshold. Thus, certain empirical characteristics describing practically observed resistance of specific subject materials and comprising certain mechanical properties of said subject materials, including hardness, fracture toughness, grain structure, and other, is a more appropriate parameter that should be used to calculate anticipated cutting speed. This may be important, for instance, for stainless steel, which at the given conditions can demonstrate cutting speeds of 5% to 20% less than carbon steel of similar hardness; it is even more important for vanadium-alloyed steels and certain super alloys. It is very important to summarize that the sum of all properties of the abrasive material and their relationship to the impact of the total resistance properties of the subject material can be plotted to determine the real threshold.

There are three primary ranges of relative hardness wherein the Particle Jet technique may be employed for correspondingly different practical tasks and demands. The post-threshold range focuses on cutting speed as the primary function whereas the relative hardness is significantly higher than the subject.

Another range is the pre-threshold range whereas the subject material has a higher impact resistance to the abrasive particles themselves. In this range, only a relatively low portion of Particle Jet energy results with material removing effect. This range is practically focusing on the restructuring the abrasive particles and/or surface engineering of subject material.

The third range is the intermediate range in proximity of the threshold value of relative hardness. This may be useful in selecting abrasive particles and subject materials to perform a compromise in cutting speeds with other desired operations such as powder production or restructuring of abrasive particles.

A relative hardness threshold also exists with respect to interaction between abrasive particles and nozzle materials that can be considered when designing a complete Particle Jet system. It is contemplated that the optimum relative hardness of abrasive is at a range intermediate the subject material and nozzle material to allow for effective cutting while minimizing nozzle wear.

It is particularly important accordingly to the present invention that the Particle Jet is employed as a cold process of micro- and nano-powder manufacturing, nano-restructuring and surface nano-engineering and thus allows this technology to obtain desired results such as improved mechanical properties of materials that no thermal process can achieve due to fast degradation of nanostructures at high temperatures. Also, Particle Jet nano-engineering realized with free moving particles submersed in liquid significantly reduces friction contrary to conventional mechanical technology using direct contact moving bodies. Friction can create adverse side affects that restrain the technology of powder and particle manufacturing, or surface treatment of materials.

Accordingly to the present invention, almost any size powder can be produced from a wide variety of materials. Other processes have problems with producing small powders effectively, especially with metals that have high fracture toughness. The collision of particles during the Particle Jet process can produce valuable powders of almost any size by fracturing upon high impact that cannot be easily duplicated by other methods.

Furthermore, Particle Jet technology can produce large amounts of nano-powdered materials more rapidly and for lower costs, than techniques known from the prior art.

Another feature of the invention is that the high-pressure, high-velocity impact in the Particle Jet process can also create new beneficial properties of particles such as higher hardness.

Byproducts of the Particle Jet process are highly valuable in some cases and can be sold for more than the cost of the original material used in the process. Other cutting processes generally do not make a profit from their waste material in comparison to the initial material costs as the waste is generally sold for less than the cost of the original materials.

The process mostly consists of recyclable and reusable media such as steel abrasive and water. There are no hazardous byproducts, like fumes, making this an ecologically sound process. All of the initial media can be reused in further Particle Jet cycles or used in other technologies, The liquid/abrasive mixture produces four main byproducts after each Particle Jet cycle, each of which can be reclaimed and recycled or reused in another application, they include: the fluid medium, the primary abrasive particles, smaller particles that fractured off from the main abrasive particles, and powders or particles that are removed from the subject material.

It is also important that optimum selection of abrasive material and specific design of abrasive particle geometry allow for the ability to reduce costs or increase life expectancy of the nozzle. Nozzles can also be made more effective through the selection and manufacture of optimized materials, designs, and methods disclosed herein.

The overall energy and cost savings of this technology is significant especially when considering that more than one product or function can be produced during one operation such as the ability to cut useful parts while producing useful powders simultaneously. There is a need to supply industry with large amounts of nano-structured powders in order to lower costs and meet demands. The need also exists to help the environment through efficient use of resources and lower energy consumption. Newly developed multi-function Particle Jet technology responds to these active industry demands.

Improvements and novel techniques for high-pressure Liquid/Particle Jet technology are disclosed herein describing more efficient uses of energy and resources compared to current Liquid/Particle Jet technology such as Abrasive Water Jet. New benefits are also realized in other areas of material processing technologies that are currently not associated with the conventional process of Abrasive Water Jet cutting. Some of the improvements and techniques can perform multi-function processes simultaneously in a single operation with at least one non-traditional product being produced at the same time with traditional cutting process. This offers essential flexibility for selecting single-function or multi-function approaches, along with traditional or non-traditional techniques to allow for various combinations of one or more of the following benefits separately or collectively: simplified classification of waste materials and byproducts; use of highly recyclable abrasive particle materials; low cost production of nano scale and micro scale powders; faster Abrasive Particle Jet cutting rates of subject materials; surface restructuring of particle materials; work hardening of particle materials; virtually synchronous three-dimensional, e.g. isodynamic treatment of particle materials; and surface treatment of subject materials. These benefits are realized through various combinations of one or more of the following improvements: use of specially designed metallic particles with specific properties and use of these particles in a Particle Jet stream; selection of metallic shot or abrasive particles at specific relative hardness in comparison to the hardness of subject materials; use of the same family of abrasive particles as subject materials; predictability of outcome for entire Liquid/Particle Jet process life cycles and cost cycles by use of software, or other means, based on scientific calculations and empirical data.

### BRIEF DESCRIPTION OF THE DRAWINGS

FIG. 1—Plot showing the general dependence of Particle Jet cutting speeds based upon relationships between steel abrasive interacting with steel subject materials at various relative hardness properties.

FIG. 2—Plot showing the dependence of Particle Jet cutting speeds based upon empirically tested interaction between steel abrasive and steel subject materials at various relative hardness properties.

FIG. 3—Charted ranges of relative hardness corresponding to maximum effectiveness of Particle Jet as: cutting technology, powder production technology, nano-structuring, surface treatment technology.

FIG. 4—Distribution chart of hardness of abrasive particles before and after impact of a Particle Jet test.

FIGS. 5 a, b—Electron microscopy photograph of steel abrasive before passing thru the Particle Jet cycle.

FIGS. 6 a, b—Electron microscopy photograph of steel abrasive with relative hardness of ˜2× greater than the subject material after passing thru the Particle Jet cycle.

FIG. 7—Electron microscopy photograph of steel shot at 60× view before passing undergoing a Particle Jet cycle.

FIG. 8—Electron microscopy photograph of steel shot at 60× view with relative hardness of ˜0.7× less than the subject material after undergoing a Particle Jet cycle.

FIG. 9—Comparative diagrams depicting the difference of basic mechanisms of multiphase material removal by mechanical machining vs. Particle Jet.

FIGS. 10, a,b—Enlarged view of the basic mechanisms of impact of Particle Jet on crystalline diamond as the example of the utmost physical limit of super-hard brittle material.

FIGS. 10, c,d—Enlarged view of the basic mechanisms of impact of Particle Jet on low cobalt cast tungsten carbide as an example of grain removal of hard ceramic material.

FIGS. 11, a,b—Complete view of the impact areas showing the basic mechanisms of impact of Particle Jet on crystalline diamond (a) vs. low cobalt cast tungsten carbide (b). Crystalline diamond shows anisotropy of removing of super-hard single crystal material; tungsten carbide gives an illuminating example of grain removal vs. crystalline structure removal combining hard and relatively soft constituents.

FIGS. 12 a,b—Empirical test results of cutting various steel subject materials with different steel abrasives at various hardness levels, and with garnet abrasive.

FIG. 13—Comparison of different scenarios to achieve end products by interaction of abrasive and subject material impact of varying relative hardness and fracture toughness.

FIG. 14—A basic Flow Chart depicting multi-functionality of the proposed invention along with the ability to recycle.

FIGS. 15 a,b—Examination of garnet abrasive before (a) being introduced into a Particle Jet, and after (b) collision between the Jet and subject material.

FIGS. 16 a,b—Examination of stainless steel abrasive before (a) being introduced into a Particle Jet, and after (b) collision between the Jet and subject material.

FIGS. 17 a,b—Examination of stainless steel shot before (a) being introduced into a Particle Jet, and after (b) collision between the Jet and subject material.

FIG. 18—Examination of garnet abrasive mixed with stainless steel subject material particles after collision with a conventional abrasivejet. The smaller stainless steel particles average about 40 microns in size compared to the initial size of about 200 microns garnet abrasive used.

FIG. 19—Diagram shows a hardness to density plot with prospective materials in hardness to density coordinates.

FIGS. 20 a,b—Critical parameters of Particle Jet cutting compared to other methods—(a) for different materials, (b) specifically for steel.

FIG. 21—Hardening of steel grit utilizing a Particle Jet technology.

FIGS. 22 a,b—Description of conventional abrasivejet technology (a) vs. new proposed recyclable and multi-functional technology (b).

### DETAILED DESCRIPTION OF THE INVENTION

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

For purposes of this patent, the terms appearing below in the description and the claims are intended to have the following meanings:

“Abrasive” means any particulate material intentionally introduced into a pressurized liquid jet in the form of sharp edge particles, such as angular, cubical, or non-spherical shapes, generally used for material removal or surface treatment upon interaction with subject material.

“Abrasivejet” means a mixture of a high pressure liquid jet stream and abrasive particles focused through a nozzle to provide for a useful tool.

“Subject material” means any material intentionally exposed to the impact of a pressurized liquid jet carrying particles of abrasive material.

“Waterjet” means a pressurized liquid stream generated by a pump, distributed by high pressure tubing, and then focused through an orifice to create a useful tool for cutting or surface treatment.

“Nozzle” means a channel that mixes abrasive with a pressurized liquid jet and focuses the abrasivejet in a concentrated stream upon exit of the nozzle tip (a nozzle is also known as a focusing tube or mixing tube). The smallest opening of the channel is the specified size of the nozzle. The specified size of the nozzle is important in determining the nozzle to orifice ratio, as all of the abrasivejet is focused into the smallest area.

“Orifice” means an opening that accepts a pressurized liquid stream and allows it to pass thru. The opening is generally specified as a diameter. The selection of the orifice size generally determines the output pressure of the high pressure system based upon the capabilities of the pump and the operating speed of the pump.

“Cutting Head” means a device used in an abrasivejet system that contains an orifice aligned to a nozzle, whereas the orifice produces a jet that is directed into the central channel area of the nozzle. The cutting head allows for the establishment of the nozzle to orifice ratio after the nozzle and orifice are installed into the cutting head.

“Nozzle to Orifice Ratio” means the total area of the smallest opening of the channel in a nozzle compared to the total area of the smallest opening of the orifice. Generally, the openings for nozzles and orifices are cylindrical in shape. For example, a conventional abrasivejet cutting head of prior art would utilize a 0.030″ diameter nozzle if a 0.010″ diameter orifice were installed, thus realizing a 3:1 nozzle to orifice ratio.

“High-Pressure” means a liquid pressure exceeding 10,000 psi.

“Metallic shot” means, spherically shaped metallic particles generally used for surface treatment of subject material rather than removal of the subject material.

“Particle jet” means a mixture of a high pressure liquid stream and particulate material(s) intended to be directed at a subject material.

“Surface Treatment” means intentional change of any characteristics of materials subjected to the impact of pressurized liquid jet carrying particles of abrasive material. Treatment may be realized by partial removing of subject material and/or change of its surface morphology (such as polishing or etching), and/or superficial structure, such as size and shape of its superficial grains, generating dislocations and/or other structural defects, and/or superficial composition of subject material by the impact of pressurized liquid jet. Treatment may be resulted with pre-designed cutting or other change of geometrical shape of subject material or with an intentional change of its superficial mechanical properties (such as hardness), and/or tribological, and/or physicochemical, and/or electrochemical and corrosion resistance properties, and/or catalytic properties, and or external appearance, reflectivity or color.

“Restructuring” means intentional change of structure of particles of abrasive material as the result of their collision with solid contra-bodies, including mutual interaction of abrasive particles in pressurized liquid jet, and/or their interaction with internal walls of the nozzle, and or their interaction with subject material. Restructuring may result in change of size and shape of grains, generation of dislocations and other structural defects, and/or composition of particles. Restructuring may be superficial or encompass actually entire volume of the particles, depending on mechanical properties of particles, on hardness of bulk contra-bodies (e.g. nozzle and subject material), the size of particles, and their density in pressurized liquid jet, pressure of jet and speed of particles.

“nano-restructuring” means restructuring resulted in change of any features of structure of particles in nano-scale, such as size grains or structural defects, in the geometric range of about 1 nm to about 900 nm.

“Surface nano-engineering” means intentional change of any features of superficial structure, and/or surface morphology, and or superficial composition of subject material in nano-scale, such as size grains or structural defects, or superficial composition in the geometric range of about 1 nm to about 900 nm along the surface or in normal to surface direction.

“Relative hardness” relates to the ratio between the mechanical properties, such as hardness, of metallic Abrasive or Shot particles used in a Particle Jet stream to the hardness of subject material.

“Hardenable” means to have the ability to increase the mechanical property of hardness on a metallic material.

“Material” means any particulate or substrate involved in a Particle Jet process.

“Cycle”—means a single incident of a Particle Jet impacting with a subject material.

“Particle(s)”—means a particulate material that has been removed from a subject material by a Particle Jet, or a particulate material introduced into a Particle Jet. Particles can be in the micro or nano size scale.

“Powder(s)—means small particulate material that has fractured off from subject material or particle material during a Particle Jet process. Powders can be in the micro or nano size scale. They can also have the same meaning as particles in some cases.

“Incident Angle”—means the relationship of the nozzle to the subject material from 0 to 90 degrees. 0 degreed being that the nozzle is parallel with the subject material so that the Particle Jet does not come into significant contact with the subject material, and 90 degrees being that the nozzle is perpendicular to the subject material while creating the maximum impact of the Particle Jet to the subject material. The incident angle can always be expressed in terms of 0 to 90 degrees as values greater or lesser do not exclude a value of 0 to 90 degrees.

“Material Separation” means the severing or fracturing of particles or subject materials into smaller sizes during a Particle Jet process.

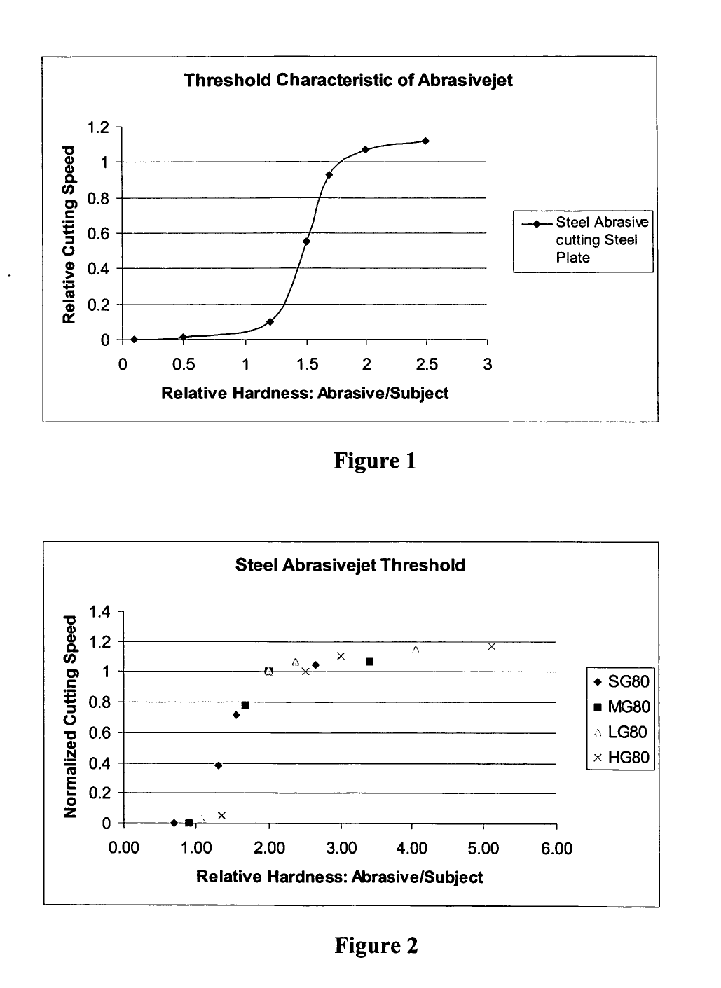

In accordance with the present invention, subject materials may be cut by a high-pressure waterjet mixed with particles that are similar to the subject material, and in the case of steel and various other metals, even chemically identical to the subject material. This is due to the threshold phenomena in Particle Jet interaction with various subject materials revealed by the authors. Schematically, the threshold for steel and hard ceramics are shown in FIG. 1 in arbitrary units for consideration only, and quantitative dependence for various metals are shown in FIG. 2 based on empirical test results.

Because the absolute values of cutting speeds of different materials as a broad range of properties as single crystal natural diamond—to tungsten carbide—to hard ceramics—to steel differentiate in orders of magnitude, it is necessary to plot (FIGS. 1 and 2) the relative cutting speeds normalized to respective cutting speeds at the threshold points.

It may be seen, the dependence of cutting speed V of tested materials in FIG. 2 is a nonlinear function of ratio of hardness of abrasive material to hardness of subject material, e.g. the relative hardness H*. Furthermore, in the case of ductile subject materials, the function V(H*) experiences a sharp and strong increase of cutting speed up to an order of magnitude in a narrow range of relative hardness in proximity of certain threshold value of H*, said function V(H*) is nearly flat in the range of H* values essentially below or essentially exceeding said threshold value.

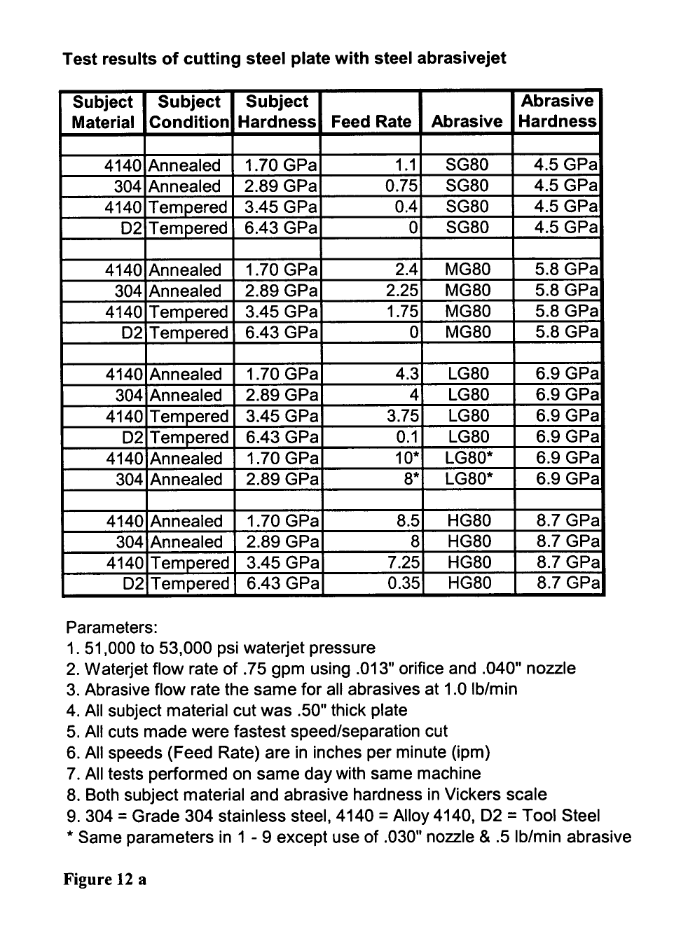

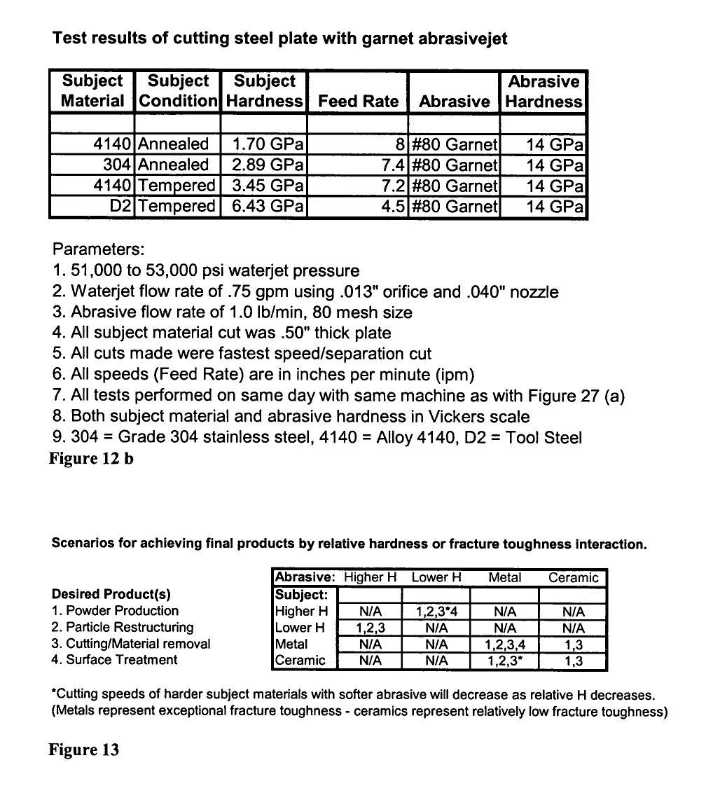

Based on this newly revealed phenomenon, it was possible to conclude that metals or metal alloys hardened by thermal or mechanical treatment or slightly modified in chemical composition with alloying elements may be employed as effective abrasive material for Particle Jet cutting of similar, or even identical, less hard metallic materials. This is especially important for cutting the majority of commercial kinds of steel and alloys that are supplied in the annealed condition. This conclusion was confirmed through systematic selection of cutting various steel subject materials with steel abrasives possessing different hardness. FIGS. 2 and 12 show the results of these systematic tests.

The particularly important characteristic feature of the Particle Jet technology in accordance with the present invention is the especial sharpness of said threshold in the case of metals as shown in FIGS. 1 and 2, including all kinds of steel and alloys, while the threshold is less strongly defined in the case of brittle materials. This difference is due to different dominant mechanisms of materials removing as it was investigated and disclosed herein. For instance, fracture toughness is very important mechanical property that heavily determines the sharpness of the threshold for metals and ceramics. Still, all materials reveal the threshold at the same or in the relatively narrow range of H*.

The cause of such strong correlation between different ductile materials as well as between different brittle materials is in the mechanisms of energy transfer from abrasive particle to the subject material in which the energy transfer underlies the cutting process. In the case of ductile subject materials, in particularly metals, the critical ratio of hardness H* corresponds to sufficient penetration of the abrasive particles into the subject material which is necessary for effective energy transfer. In the case of brittle subject materials, the shock produced by the impact of abrasive particles generates and propagates micro- and nano-cracks, and for this energy transfer mechanism the hardness of abrasive particles is of less critical importance as shown in FIG. 1.

The energy transfer of the abrasive particle upon impact with subject materials is the combination of many facets such as size, shape, sharpness, velocity, fracture toughness, hardness and mass of the particle. These facets combine to form the overall energy of impact.

Carbon steel abrasives of the necessary density, hardness and sharpness were available and tested by the authors but were determined to be inferior to stainless steel and alloy abrasives in the areas of ductility and corrosion resistance. It was determined that carbon steel may be useful in some areas of cutting certain carbon steels or other materials such as stone that do not have an adverse effect of corrosion. Most metals cut currently by Particle Jet such as stainless steels, aluminum and titanium would experience surface rust inhibited through contact with carbon steel abrasive. This corrosion would often times need to be removed by prior art methods such as waterjet cleaning or sand blasting thereby adding a cleaning process that would add extra overall costs.

A further disadvantage of carbon steel abrasive is the reduced ability to sell the waste or byproduct material at high levels such as mentioned in other areas of this disclosure. The ability for the Particle Jet technique mentioned herein allows for the production of powders and restructured particles derived from certain types of abrasive material used. Most of the non-Particle Jet applications that use powders or particles require corrosion resistant materials therefore the ability to sell Particle Jet byproducts to these markets would be diminished by using and offering carbon steel powders and particles.

Improvements to abrasive particles through the implementation of pre-engineered abrasives with good corrosion resistance and high recyclability are determined to be the optimum solution for most Particle Jet applications. Greater amounts of cutting energy are transmitted when using sharp points or edges as the surface area of impact is reduced and the kinetic energy of the impact is realized into smaller areas of the subject material.

Another major facet that can be known is the relationship of nozzle wear to cutting of subject material based upon the relative hardness plot as shown in FIGS. 1 and 2. This knowledge can be used to optimize selection of the abrasive and nozzle materials. For example, the mechanical properties and structure of the subject material are fixed for the application to be performed but the mechanical properties of the abrasive material are not fixed and can be selected in proximity of the relative hardness threshold, e.g. the selected abrasive material may possess relative hardness only slightly exceeding the threshold value. Significantly faster cutting speeds are not realized proportionally to abrasive hardness above the threshold so that minimum hardness levels of abrasive particle can be selected so to minimize nozzle wear without sacrificing speed.

The best situation for faster cutting speeds and lower operating costs is the selection of abrasive particles that are harder than the subject material but softer than the nozzle material at optimized levels. This relationship between materials is also most important in cutting because it can be used to increase the abrasive particle energy for greater cutting speeds. Selection of abrasive particles that are hard enough to cut effectively but soft enough for slower nozzle wear allows for further optimization of the nozzle to orifice ratio which creates higher particle velocities as disclosed in other areas of this disclosure. It is important for costs to have nozzles last hours and not wear out in minutes therefore the selection of the abrasive hardness is crucial for costs and so that particle speed can be increased to the maximum amount allowable without significantly wearing out the nozzle. Due to lower hardness and higher density of abrasive material, further optimization of nozzle becomes available to the essentially smaller diameter of nozzle and respectively lower ratio between nozzle and orifice diameter to create higher speed/energy of particle speeds and better focused cutting energy.

It is known that optimization can be difficult when many facets of the Particle Jet process are considered collectively but the authors have made significant improvements in the use and optimization of metals and other heavy abrasive materials in the Particle Jet process. There are two main considerations in the areas of density and fracture toughness where these heavy abrasives are better suited for the Particle Jet process compared to garnet and other conventional abrasives such as alumina. These improved properties create more cutting energy especially when compared to garnet. The specific gravity of steel used as abrasives as disclosed herein is approximately twice as high as garnet while the fracture toughness of steels are orders of magnitude higher than garnet.

The plot shown in FIG. 2 summarizes the results of cutting with various steel abrasives against various steel plates, while FIG. 12 (a) specifies quantitative results of these tests. The summarized plot in FIG. 2 was normalized at V to better compare the many different kinds of steel (hardness variations) used in the tests. The underlying physical law becomes clear in every instance: the cutting speeds did not significantly increase after reaching a relative hardness of 2.0. FIG. 12 (b) shows quantitative results of cutting tests of steel with garnet abrasive. It may be seen, that the hardest steel abrasive demonstrates higher feed rates of annealed plates even though its hardness is about 40% less than garnet hardness.

When the speed of the particles and all other parameters are the same, heavier particles will have a greater cutting impact compared to lighter particles not only due to the higher impact energy, but also because the higher values of fracture toughness are usually associated with heavier particles such as zirconium oxide, steel, alloy, and tungsten particles when compared to lighter conventional abrasives such as garnet, alumina, and silicon carbide. Lighter particles with lower fracture toughness often break down upon impact with the subject material thereby reducing the mass and energy of the particle to continue cutting. Higher fracture toughness of abrasive particles also enables better recycling of the abrasive. Therefore there are two very beneficial reasons to use abrasives of higher fracture toughness (faster material removal and higher recyclability). Higher hardness levels of abrasive materials such as alumina or silicon carbide often times do not improve cutting speeds as their low fracture toughness and light density are now considered as negative properties for Particle Jet by the authors.

Costs are generally higher for the initial cost of heavy abrasives compared to lighter abrasives but not when the final costs of the whole Particle Jet process are considered as disclosed by the authors. The ability to recycle through the use of heavy abrasives with high fracture toughness often is the greatest determining factor for the lowest possible overall cost. For example, stainless steel abrasives may have an initial cost of $3.00 per pound where garnet abrasive may only have an initial cost of $0.30 per pound but the ability to achieve over 10 recycles of stainless steel abrasives allows for an immediate leveling of costs.

There are also many other considerations that make heavy abrasives better suited for the Particle Jet process such as the ability to cut at faster speeds than lighter materials when considering greater particle energy. The ability to easily classify and sell byproducts of value also reduces costs whereas garnet is generally considered as waste because is breaks down into smaller undesirable powders often adding a cost premium for disposal.

In the case of steel of all grades examined by the authors, the strong threshold distinctly separates the pre-threshold range of abrasive hardness with very low cutting rate and post-threshold range with nearly maximum cutting rate in the entire range, as shown in FIG. 2. For all kinds of reliably tested steel, the threshold values locate in the range between 1.4 to 2.0 of relative abrasive hardness, while the values in the range of 1.5 to 1.6 are predominantly the greatest areas of transitional sloping shown in the plot.

Further investigations may reveal different values of threshold due to the high amount of variables and many facets of the Particle Jet process, however, the principle phenomenon of threshold, not its specific value, reflects the essence of the present invention, and may not be limited with specific threshold value. Hardness alone may not determine threshold.

The principle phenomenon of threshold in accordance with the present invention is relatively sharp change of cutting speed of certain subject material in three folds or stronger in relatively narrow range of abrasive hardness between certain minimum value H*₁ and maximum value H*₂, wherein H*₁<H*₂<2H*₁.

Typically in the case of ductile metals, said sharp change of cutting speed of subject material exceeds 3 folds in relatively narrow range of abrasive hardness between certain minimum value H*1 and maximum value H*2, wherein H*₁<H*₂<1.5H*₁.

In specific example shown in FIG. 2, the increase of cutting speed of subject material reaches about order of magnitude in the range of abrasive hardness H*₁<H*₂<1.5H*₁.

FIG. 2 shows that in the post-threshold range increase of cutting speed of various steels, including mild steel and stainless steel, does not exceed 20% while the relative hardness of abrasive is changed in three folds or more. This is one of key tendencies in the Particle Jet process underlying the present invention although other values may be found.

Because relative hardness of steel abrasive of about 2.0 with respect to the steel subject material tested is sufficient to reach about 80% of the utmost maximum of physically achievable cutting speed at the given Particle Jet conditions, similar solids may be employed as abrasive and subject materials. For instance, hardened steel abrasive may be used to cut various softer steels, including the same type of annealed subject steel. Furthermore, in the post-threshold range of relative hardness, the other properties of abrasive material, such as fracture toughness, shock resistance and density contribute in the cutting process equally or even stronger than hardness. More specifically, higher fracture toughness and shock resistance of abrasive material decreases the probability that the incident abrasive particles will be fractured, while preservation of abrasive particles in basically intact state is important for effective energy transfer to the subject material. On the other hand, higher density increases the energy of the incident particle at the given speed.

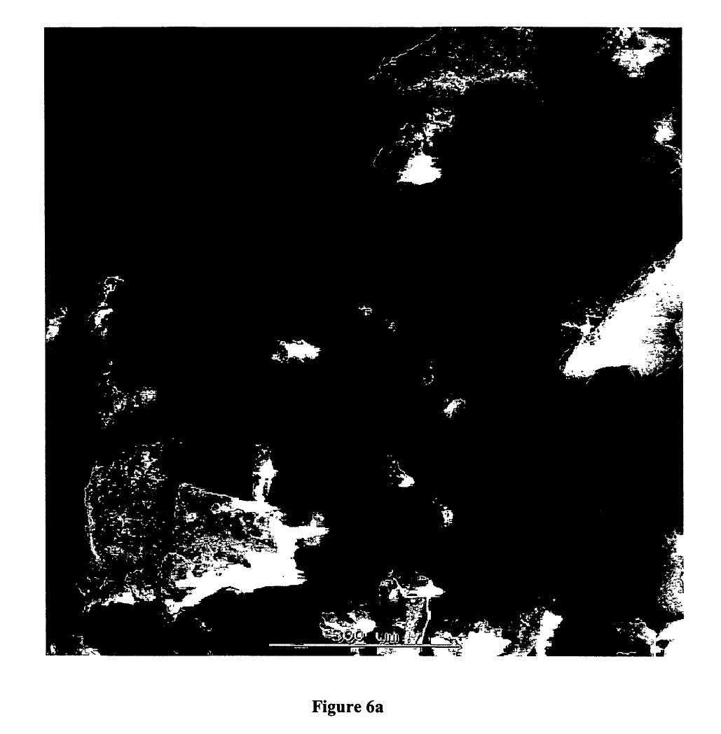

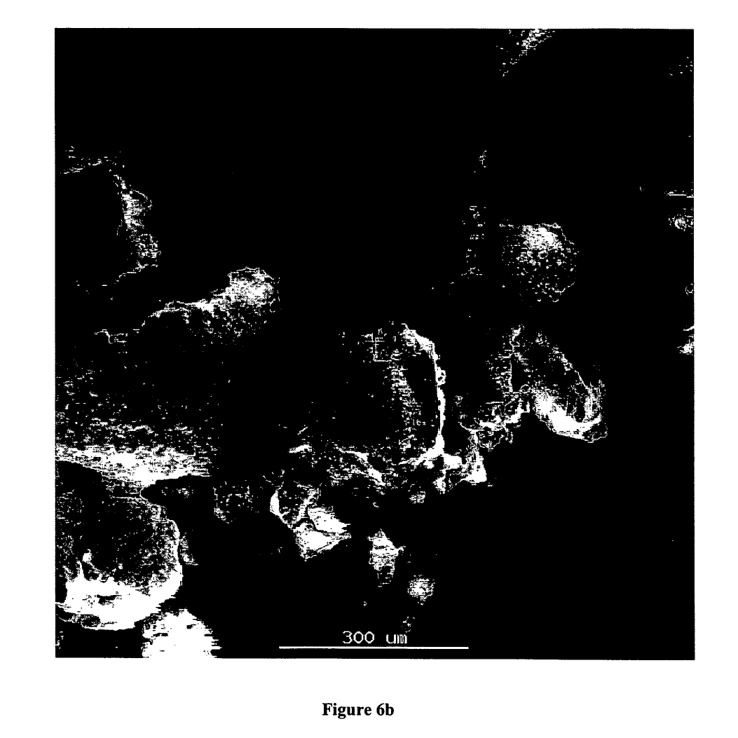

The size and geometry of steel abrasive experiences only a minimal change while passing through the cutting process as it may be found while comparing the electron microscopy photographs: FIG. 5a vs. FIG. 6a, and FIG. 5b vs. FIG. 6b. Note: These two pairs of photographs made with different electron microscopes and in different laboratories. This shows high recyclability of steel grit for Particle Jet technology.

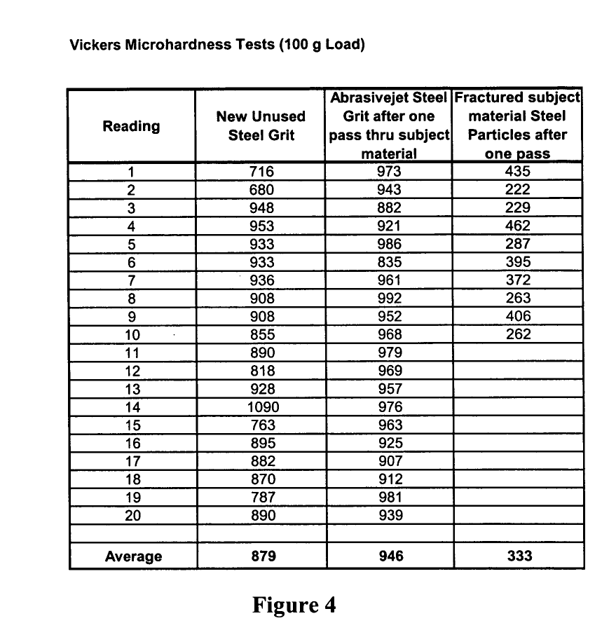

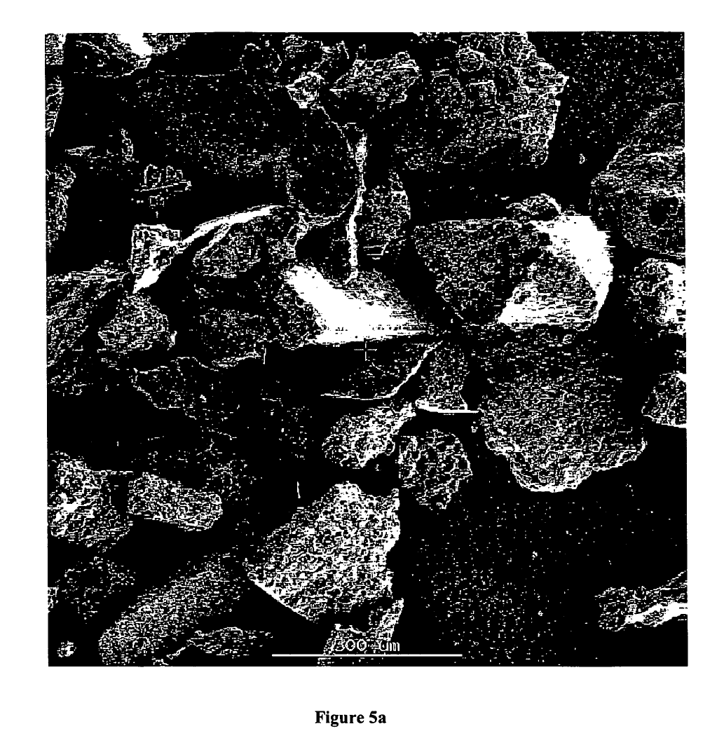

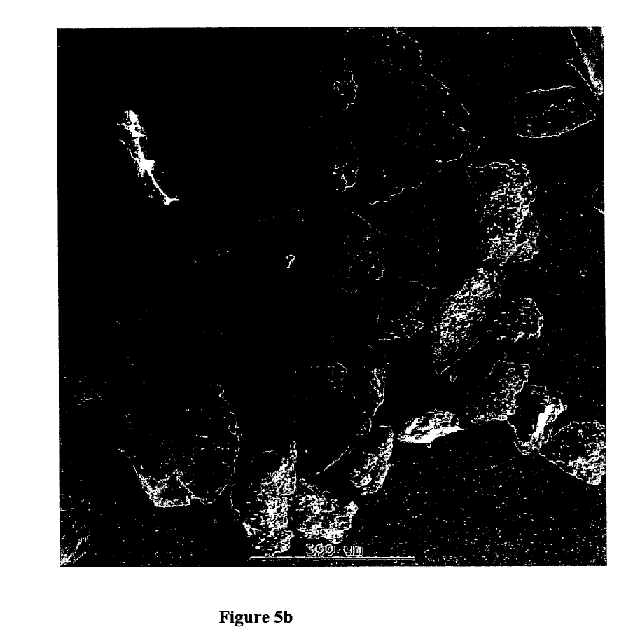

In the same time, there is en evident hardening effect of said steel grit passing through the Particle Jet cutting process, as it may be seen in FIG. 4. Furthermore, the hardness values of steel particles are approaching a physical limit, and the distribution function is correspondingly narrowing as shown in FIG. 4.

FIG. 4 shows distribution chart of hardness of abrasive particles prior to the first pass through the Particle Jet process. Also shown on this chart is the hardness of abrasive particles after one pass of cutting through steel subject material with steel grit possessing a relative hardness of ˜2 times greater than the subject material. The hardening effect may be clearly seen as an improvement.

Isodynamic treatment of the abrasive particles occur inside the cutting head and from impact into the subject material during high-pressure impact. The particles will impact each other as the result of mutual collisions. This is slightly different from restructuring by subject material impact alone because surface treatment is realized by particles bouncing back from the subject material and deflecting off of each other. Numerous treatments of particle restructuring occur in one Particle Jet cycle as many collisions occur between particles inside the cutting head and out.

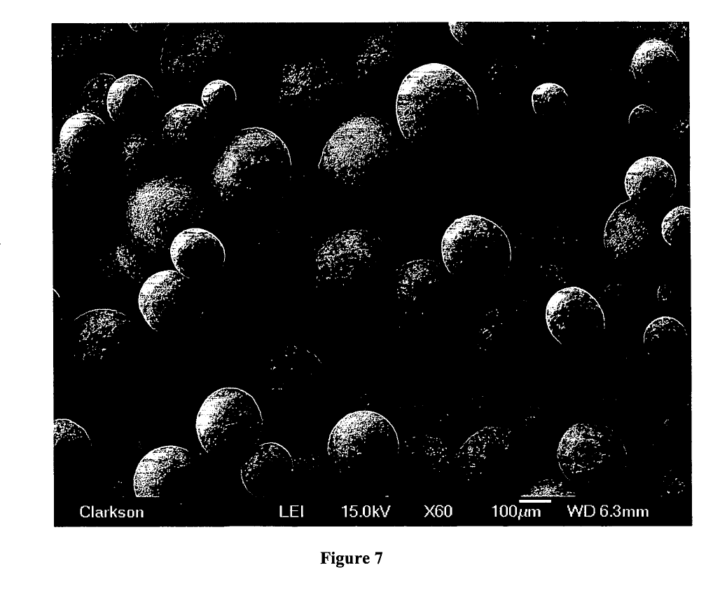

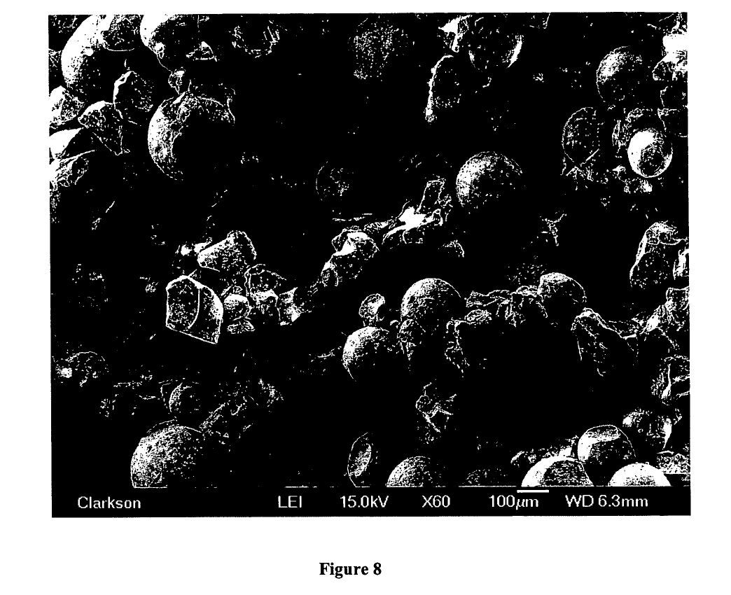

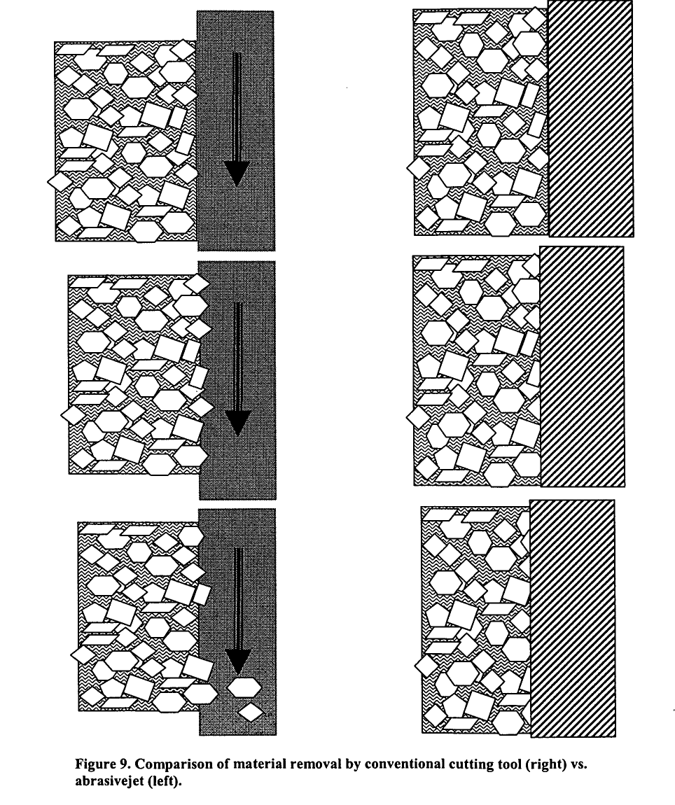

Still another feature of the present invention is that prior to threshold, e.g. at relatively low hardness of abrasive material, the predominant portion of the abrasive jet energy may be directed into fracturing and restructuring of abrasive particles themselves, especially by use of abrasive particles with pre-designed shape. FIGS. 7 and 8 show microphotographs by electron microscopy for stainless steel taken prior and after one pass by the Particle Jet against a harder steel sheet subject material. Both fracturing of essential portion of steel shot and its surface restructuring after one pass may be clearly seen by comparison of these microphotographs. In another area, the removing speed of subject material by said steel shot was about or below the resolvable minimum.

Newly found nano-technology benefits in Particle Jet techniques disclosed herein are also realized in conjunction with metals to be used in many applications of manufacturing industries such as with moldings, thermal spray coatings, grinding wheels, powders do not produce any waste product, and the more cycles the metallic powder sustains, the more valuable the byproduct, both in physical size and in desirable mechanical properties.

Separation and classification methods of abrasive particles can be accomplished utilizing prior art such as vibratory screeners, filters, dryers, positive/negative air pressurization, or magnetic charge. Cutting of subject materials on tables with slats or grating of the same family of materials can be utilized to prevent contamination of the byproducts.

Examples of surface treatment can include peening, mechanical hardening and cleaning. Other methods of material removal can also be used to produce nano-structured powders such as milling or etching although they are more similar to cutting than surface preparation. Hence, Particle Jet mostly known by prior art as cutting, etching and shape forming technology, can be transformed based on the present invention into material production technology while simultaneously transforming it into virtually waste-free technology.

More specifically, this technology allows production of micro- and nano-powders of various metals and non-metallic materials, surface treatment and nano-restructuring of micro- and nano-powders, and plausibly producing new kinds of products, such as micro- and nano-powders with chemically modified superficial layers, for instance—passivated nano-powders, safe explosive powders, supported catalyst in “atomized” form, etc. There are no strict limits for the resulting particles size up to deep nano-level, although productivity and cost would unsurprisingly increase with the particles' size decrease.

abrasives, tooling, substrates and structures of a wide variety of shapes and beneficial properties. Examples of overall improvements can be described by comparing hard materials. It is known that hard alloys have many better properties over other hard materials such as carbides and ceramics used in manufacturing today but there are hardness limitations with metals and alloys that prevent them from being used where very hard materials are required. Generally ceramics and carbides are harder than alloy steels but they also can be brittle as well. Alloy steels may not be as hard as ceramic and carbide materials but they have exceptional fracture toughness, as they do not break apart as easily carbides or ceramics. Corrosion resistance is also another major consideration in selecting materials.

By comparing the desirable properties of metal and ceramic materials, it can be shown that Particle Jet nano-structuring can cross the gap between material selections and invert limitations into practically useful technological features. A feature benefit of the Particle Jet process is that it is a cold working process to treat metal abrasive particle materials or subject materials through work hardening. This cold process allows for higher hardness levels above tempering processes that have lower hardness limitations.

Metallic powders, including most of major kinds of steel and alloys, are effectively restructured during Particle Jet processing and through further recycles, thereby evolving them into highly demanded nano-grain material. These restructured powders can achieve higher hardness levels over conventional metals while maintaining higher fracture toughness properties over ceramics to allow for very desirable properties. Also, metallic powders of any mesh classification possess high market value (this value progressively grows as the particle size decreases). It is plausible that use of metallic

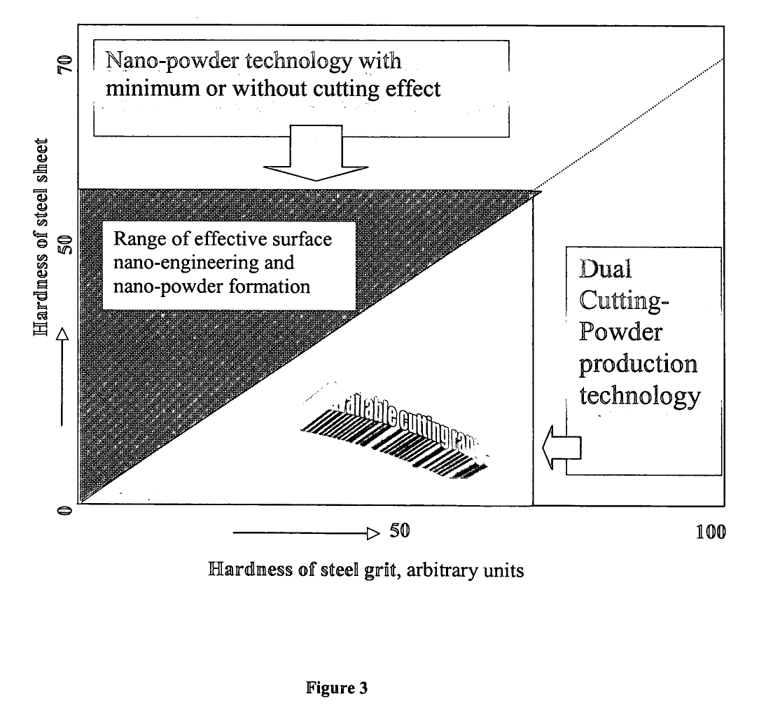

The threshold characteristics of Particle Jet impact onto the subject materials allow clearly distinguishable ranges of relative hardness corresponding to predominantly material removing impact or predominantly restructuring impact. Correspondingly, FIG. 3 shows the ranges of relative hardness feasible for Particle Jet as cutting technology vs. powder production and/or nano-structuring technology. The range of predominantly material removing impact with respect to subject material corresponds to predominantly restructuring of abrasive particles, and vise versa, material restructuring impact with respect to subject material corresponds to predominantly fracturing of abrasive particles.

This new technology allows for production of various powders, possibly even some explosive ones. This is due to low-temperature and liquid, typically—water, milieu. Conceptually, it is possible to develop this technology further for special work conditions, such as under deep-water cutting, fast emergency cutting, and even for military purposes (fast penetration into rocks, concrete, steel, etc).

Also in accordance to the present invention, the Particle Jet techniques may be employed for accelerated testing of abrasive particles or subject materials. Said accelerated testing is based on selection of abrasive material corresponding to appropriate Ha/Hs ratio with regard to subject material subjected to accelerated tests, or inversely, on selection of subject material corresponding to appropriate Ha/Hs ratio with regard to abrasive material subjected to accelerated tests. In specific examples, wear resistance of metallic parts of automotive, or avionic or other machinery in severe conditions, such as metallic parts subjected to intensive cycling in dusty environments, the accelerated tests using waterjet carrying appropriately selected abrasive typically only need one or a few minutes of test duration while a common technique known from prior art requires hours, or days, or even a longer period of time. Similarly, test of shock resistance of certain material by the Particle Jet usually requires one run only, e.g. one or a few minutes of test time. This is illustrated with photographs showing steel shot prior and after one pass through a Particle Jet cycle (FIGS. 7 and 8) and steel abrasive prior and after one pass through a Particle Jet cycle (FIGS. 5 and 6). Both steel abrasives passed tests in a relative proximity of the threshold value of H*. It is clearly evident that steel abrasive is virtually unchanged after one pass, while essential part of shot is fractured after one pass. The differences were determined very rapidly as the resulting difference can be ascribed to different relative hardness levels mainly due to different fabrication technologies of shown steel shot and abrasive.

FIGS. 5a and 5b are electron microscopy photographs of steel abrasive possessing relative hardness ˜2 times greater than the subject material before passing thru the Particle Jet cycle, and FIGS. 6a and 6b are electron microscopy photographs of the same steel abrasive after passing thru the Particle Jet cycle. There is no essential change of particles' shape or size revealed by comparison FIGS. 5 and 6 although some additional fractured particles of subject material can be seen in FIGS. 6a and 6b.

FIG. 7 is an electron microscopy photograph of steel shot with relative hardness ˜0.7 times less than the steel subject material before passing thru the Particle Jet cycle. FIG. 8 is an electron microscopy photograph of the same steel shot after passing thru subject material in Particle Jet cycle. The fracture of essential portion of particles is clearly visible.

Also revealed is a principle difference in basic mechanisms of material removing by mechanical machining vs. Particle Jet impact. FIG. 9 is a schematic comparative diagram showing difference of basic mechanisms of multiphase material removal by mechanical machining vs. Particle Jet. The main difference is that the intensity of impact by mechanical machining is defined predominantly by the hardest component of the subject material, while the intensity of impact by the Particle Jet is defined predominantly by the softest component of the subject material and depending on its percentage of chemical composition. This is equally crucial for cutting of subject materials or treatment by Particle Jet, and for selection of construction material for nozzles or other equipment component subject to Particle Jet impact.

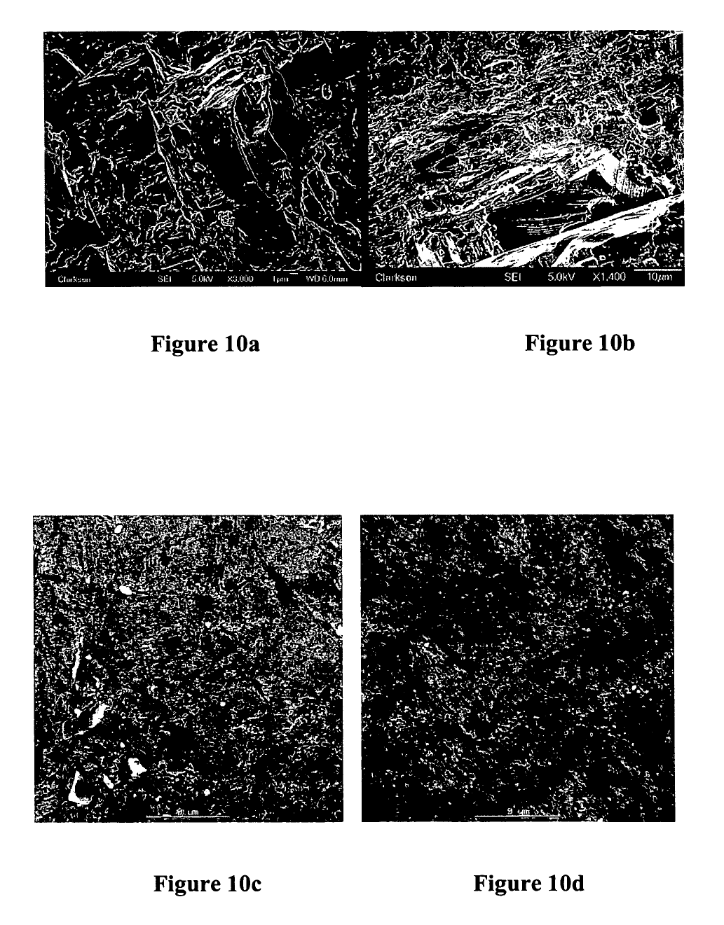

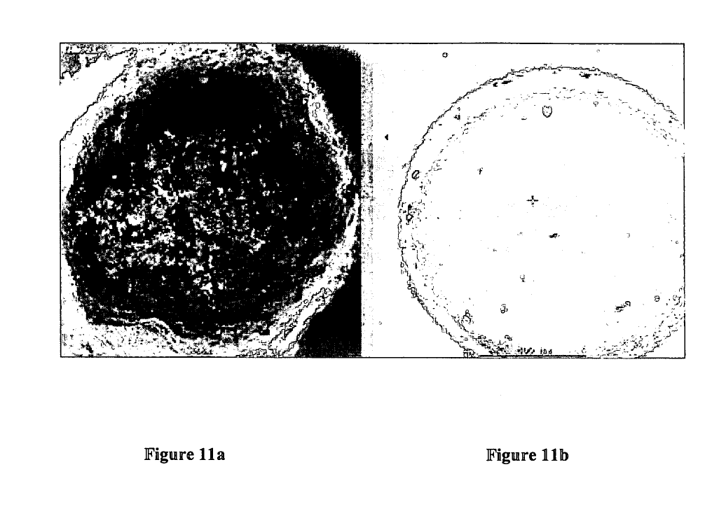

FIGS. 10 and 11 show the results of comparative examination of impact of alumina Particle Jet on the natural crystalline diamond and cast low-cobalt tungsten carbide.

FIGS. 10a and 10b illustrate the basic mechanisms of impact of Particle Jet on crystalline diamond as the example of the utmost physical limit of super-hard brittle material. In the center of the diamond crater, the morphology shows the dominant elements of liquid anisotropic etching. The shape of the structures shows orientation of normal to surface axis close to <111>, in correspondence with the shape of crater (FIG. 11a). This kind of morphology after treatment by the Particle Jet of high-speed solid particles may be only produced as the result of cracking and cleavage. The diamond morphology show combination of anisotropic etching by liquid chemical agents, the glass-like fracturing, relatively smooth morphology of common erosion, and hairline cracks commonly occurred in diamond crystals subjected to too fast cutting or polishing.

The appearance and proportions of this feature strongly differentiate on the bottom and on the walls of crater, and clearly depend on crystallographic orientation of the particular portion of the wall, as well as along the profile from flat proximity to crater, through the top edge, and down to the flat bottom of the crater.

Opposite to diamond, the grain-removing mechanism is the absolutely dominant mechanism of WC wear by the Particle Jet. Based on the photos of FIGS. 10c, 10d and 11b, one may assume that this cast tungsten carbide is not a homogenous one-phase material, but rather two-phase solid where the grain of one phase have typical size in relatively wide range from ˜1 micron to ˜10 micron, without predominant shape (although some grains are apparently plate-like), while the second phase has elongated shape with less than one micron cross-section diameter.

FIGS. 11a and 11b show the basic mechanisms of impact of Particle Jet on crystalline diamond and low cobalt cast tungsten carbide as the examples of grain removal vs. crystalline structure removal combining hard and relatively soft constituents. The crater in the diamond (FIG. 11a) is visibly anisotropic and explores the symmetry of crystal. The “table” facet has orientation (111), which is the hardest and unusual for diamond cutting. The crater in WC (FIG. 11b) has simple circular shape in plane and appears on the photograph with semispherical profile.

In another area, in the case of single crystal diamond there is no harder material, and the brittle fracture represents virtually only cutting mechanisms. However, in the case of hard polycrystalline materials consisting of one pure material, such as polycrystalline diamond coating, the inter-grain bonds are crucial; usually, the strength of these bonds are in order of magnitude lower than the intrinsic strength of grain. This results with drastically lower Particle Jet resistance of polycrystalline diamond coatings vs. single crystal diamond, as experimentally revealed by the authors. It was found that polycrystalline diamond coatings are significantly less resistant to alumina abrasive/water jet impact than many conventional materials.

In the case of hard polycrystalline materials consisting of hard grains bonded by a softer material, such as tungsten carbide with cobalt binder, the relatively lower resistance of the binder is critical, as it was quantitatively examined by grain-by-grain dissembling as the major mechanism of subject material removing by Particle Jet. This mechanism is characterized with very low removing rates when the predominant size of abrasive particles is much greater than the average thickness of inter-grain binder (specifically, the 80-mesh garnet was used as the abrasive in these tests). Correspondingly, the cutting speed of cast WC—Co by garnet is very low in spite the garnet is much harder than cobalt. This is due mainly to the chemical composition of Co being very low in relation to WC such as 99% WC and only 1% Co.

The angle of impact of the Particle Jet upon the subject material is another important mechanism of material removal. Harder materials such as low cobalt cast WC have lower impact resistance to the Particle Jet at perpendicular impact as it is often more brittle than other hard materials upon direct impact. However, when the angle of the jet is reduced to a minimum angle such as 10 degrees, the ability of low cobalt WC has greater ability to deflect the jet and not break apart easily. Conversely, higher cobalt content of 6% demonstrates greater ability to resist the Particle Jet at 90 degrees but less ability to resist grain removal at minimal angles when compared to WC with lower cobalt.

FIG. 12 depicts empirical test data by the authors used to determine the relative hardness plots for steel as shown in FIG. 2. This demonstration shows that as the hardness of steel abrasive particles increase, the cutting speeds sharply increase until the post-threshold proximity; however, in the far post-threshold range the cutting speed increase rate dramatically lessens. The threshold of the subject material cutting speed was also verified by additional empirical data (not all shown) using many other abrasive particles such as garnet (shown), silicon carbide, aluminum oxide, and tungsten carbide. With all parameters being equal except for abrasive, the maximum cutting speeds of various steel subject materials were all approximately the same above the post threshold. All of these abrasives were harder than the hardest steel abrasive tested in the ranges of 14 to 22 GPa Vickers hardness. In conclusion, annealed steels or medium tempered steels are not cut significantly faster by use of conventional Particle Jet cutting heads with any abrasive tested of 2.0 or greater relative hardness.

The benefit of knowing the relative hardness threshold allows for the ability to use smaller nozzle to orifice ratios by selecting abrasives such as steel that are softer than garnet and do not wear the nozzle as quickly. It also helps to increase particle energy and allow for faster cutting speeds.

The ultimate goal of Particle Jet cutting technology is to provide a satisfactory quality surface finish onto the subject material at the lowest possible cost. Thru cutting of the subject material in length of travel is the main aspect of cutting; typically, removing of a wider channel of material is not required or desired. By focusing of the Particle Jet particle energy into a smaller diameter nozzle, less width of cutting is produced but longer lengths of travel are experienced with the same amount of possible fluid energy from the pump. The output pressure and flow rate of the pump is limited at the maximum capability of the pump but the cutting head is the apparatus that efficiently or inefficiently utilizes the same amount of fixed fluid energy to produce Particle Jet cutting energy.

FIG. 13 summarizes a comparison of different scenarios to achieve end products by interaction of abrasive and subject material impact of varying relative hardness and fracture toughness. Knowledge of relative hardness can be utilized to optimize the number of recycles performed by implementing the lowest possible hardness in order to obtain higher fracture toughness. Use of annealed or tempered metals can be called out at the desired mechanical properties to determine to lowest costs. Either, faster cutting speeds can be obtained with harder abrasive, or greater recycling can be performed with better fracture toughness. It is depends on the application to determine the lowest cost but a compromise of hardness and fracture toughness can be selected to achieve benefits of suitable cutting speeds and recycling together.

Metal abrasives are determined to be the best all around abrasive for most applications except for certain areas such cutting of very hard materials with Particle Jet. In this case similar hard ceramic or crystalline material abrasive may be better suited.

As it can be seen in FIG. 13, metal abrasive particles and metal subject materials can be restructured through surface nano engineering. Ceramics (and crystalline materials) often fracture too easily from the impact of the jet and are too hard to make any improvements to the surface other than purely cosmetic.

Metals and ceramics tables shown in FIG. 13 can also represent Particle Jet impact upon same family or different families of materials. Metals represent exceptional fracture toughness, while ceramics represent relatively low fracture toughness.

After every cycle the abrasive material can be reused in a further cycle or classified and sent to an alternative application. It is not a necessarily requirement that the same family of materials for both the abrasive and subject material are used for recycling as simple classification methods can be used to separate different families, but preferably the abrasive is a metallic material. The relationship of hardness and fracture toughness directly relate to recycling so the mechanical properties of the abrasive determine how many cycles can be performed, how long the nozzle lasts, and how fast the process speed is.

Simultaneous production of powder and/or restructured particles can be performed along with either cutting or treatment allowing for up to three useful products or byproducts to be produced in one Particle Jet process. However cutting and treatment cannot be performed simultaneously as they are opposite to each other.

There are four major functions corresponding to different end products that the disclosed Particle Jet technique can perform. The following is a summary of possible scenarios of their relationships to each other in production:

Powder Production can be performed as a sole product or along with another function such as cutting and/or surface treatment—abrasive material can be recycled until desirable size is reached and then removed from the Particle Jet process;

Particle Surface Treatment can be performed as a sole product or along with another function such as cutting and/or surface treatment of subject material—abrasive material can be recycled until desirable properties are reached and then removed from the Particle Jet process;

Cutting or Material Removal can be performed as a sole product or along with another treatment such as powder production and/or particle surface treatment—abrasive material can be recycled in order to continue to cut parts until processing speeds or costs are not acceptable, abrasive waste can then be sold as scrap, or classified powder and/or particle byproducts can be sold at any time when they reach a desirable size distribution or desired mechanical property;

Surface Treatment of subject material can be performed as a sole product or along with another treatment such as powder production and/or particle restructuring-abrasive material is recycled until desired surface treatment is realized, reused in other Particle Jet processes, or sold as abrasive, powders, or particles to non-Particle Jet applications if desirable improvements are reached.

A short example displays how larger abrasive particles can be used for one process and then transferred to the next process that requires smaller size particles. This transfer can be performed over and over again until final desired sizes are reached. This is mainly achievable through the synergetic process of easy recycling through the use of same family type materials. Abrasive materials can be transferred from one application to another as particles fracture each cycle until final byproducts are realized. Therefore, abrasive materials can be used in many cycles, not only for each type of process but for other processes as well, whether it is a similar process as originally conducted such as in material removal or a completely different process such as surface treatment.

Start >> begin with size 200 to 300 micron abrasive particles >> use in rougher grinding or cutting >> particles fracture into smaller sizes and are transferred to second level

Second Level >> size 100 to 200 micron particles >> used to achieve medium quality surface finishes >> particles fracture into smaller sizes and are transferred to third level

Third Level >> size 1 to 100 micron particles >> used in finer polishing or cutting processes >> particles fracture into smaller sizes and are transferred to the final level

Final Level >> Nano size powders >> Final particles captured from the above levels >> can continue to use in material removal cycles or transfer for use in other processes such as sintering of materials or material coatings.

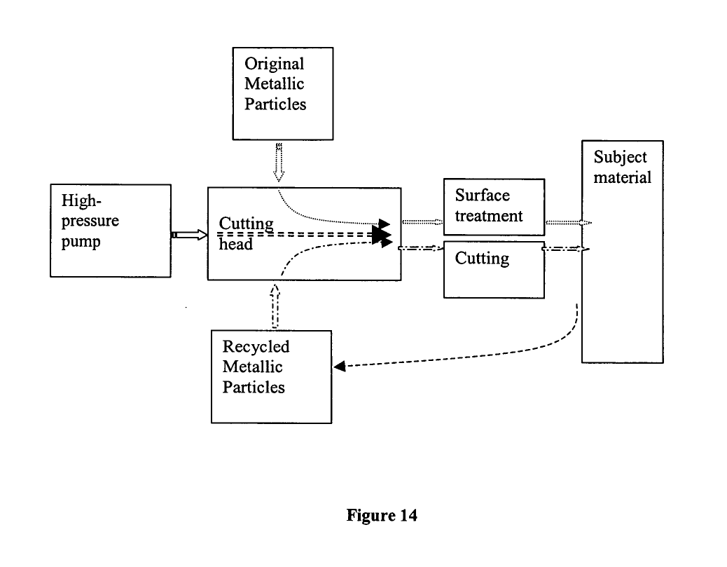

FIG. 14 depicts a basic Flow Chart for the multi-functionality of the proposed invention along with the ability to recycle.

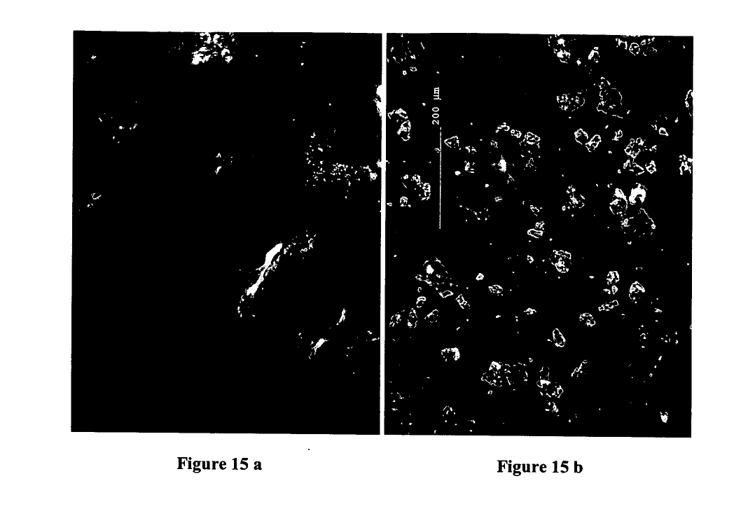

FIG. 15a depicts 80 mesh garnet in its original state while 15b depicts garnet after just one impact with subject material in a Particle Jet process. It can be clearly seen that garnet does not have the recyclability as heavier metallic abrasives.

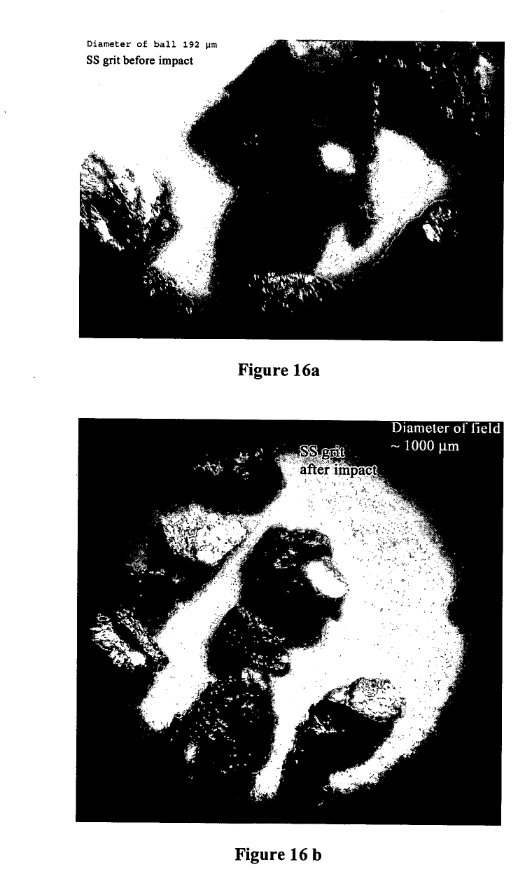

FIGS. 16 a,b examines stainless steel abrasive before (a) being introduced into a Particle Jet, and after (b) collision between the Jet and subject material. Under the same test conditions as garnet abrasive in FIGS. 15 a,b, at 50,000 psi, stainless steel abrasive demonstrates high resilience to impact. The same approximate average weight of the particles were measured at 0.000011 grams per particle for both before and after impact.

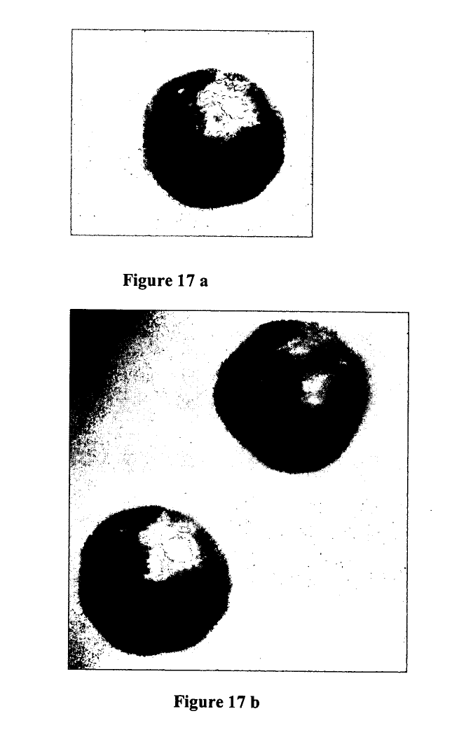

FIGS. 17 a,b examines stainless steel shot before (a) being introduced into a Particle Jet, and after (b) collision between the Jet and subject material at 50,000 psi. Hundreds of similar particles were examined with the same results. This provides for a visual demonstration that stainless steel material has high impact resistance to the Particle Jet process.

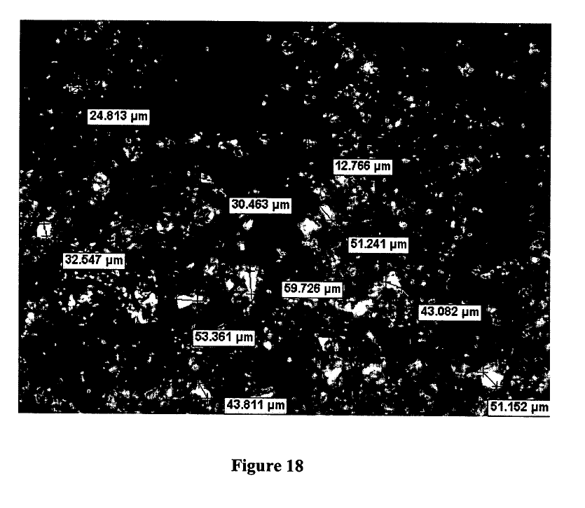

FIG. 18 examines garnet abrasive mixed with stainless steel subject material particles after collision with a conventional abrasivejet. The smaller stainless steel particles average about 40 microns in size compared to the initial size of about 200 microns garnet abrasive used. This demonstrates that the separation of subject material by a Particle Jet produces significantly smaller particles of the subject compared to the original size of the abrasive particles. This process can be scaled to produce very small nano scale powders as the subject material separated is always smaller than the abrasive material delivered in the Particle Jet.

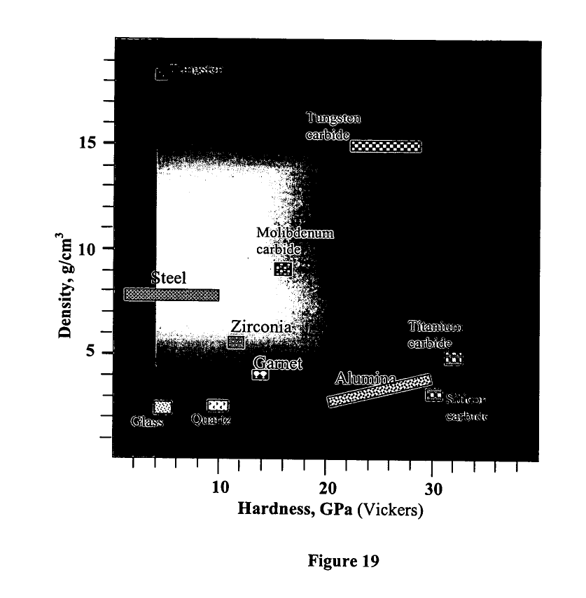

FIG. 19 depicts a table of prospective materials for Particle Jet technology based upon hardness and density as these two properties seem to be the most important properties of all Particle Jet technology, especially for multi-functional use.

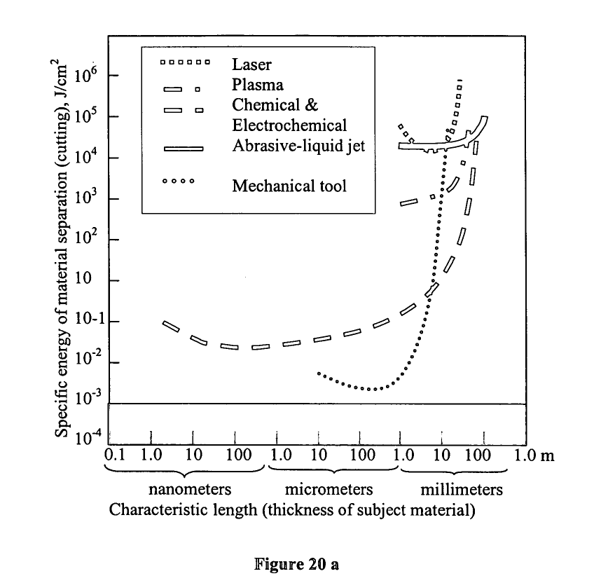

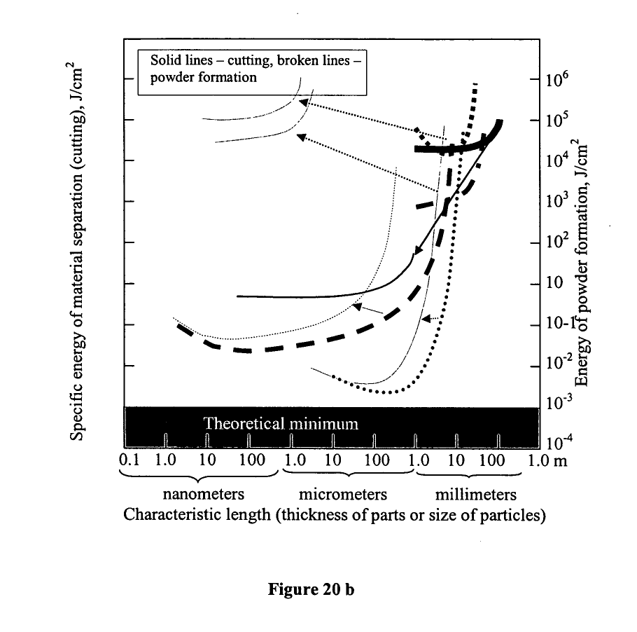

FIGS. 20 a,b depict the critical parameters for Particle Jet technology compared to other technologies (a) for different materials, (b)—specifically for steel. Each dot on these plots is the result of a systematic set of experiments defining critical cutting speed for specific combination of subject material and abrasive material at the given conditions of the abrasive-liquid jet formation. Plots were built on defined series of critical values of cutting speed, in turn, defining the critical values (threshold) of relative hardness. Consequently, this threshold allows transforming routine cutting machinery into multifunctional waste-free technology.

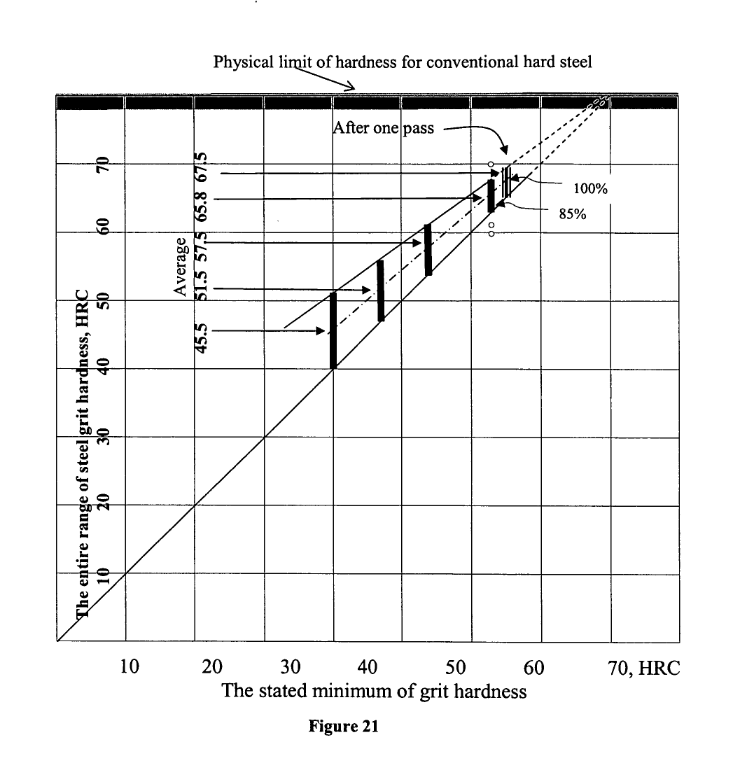

FIG. 21 charts the hardness trend of 4 carbon steel abrasive grades available from industry along with one grade processed by Particle Jet technology from the results shown in FIG. 4. It may be expected that there is a threshold of hardness that will be reached after several cycles at the current technology level. However, improvements to this approach at higher pressures may indeed turn metals into very hard materials such as with ceramics and carbides but still offer better fracture toughness.

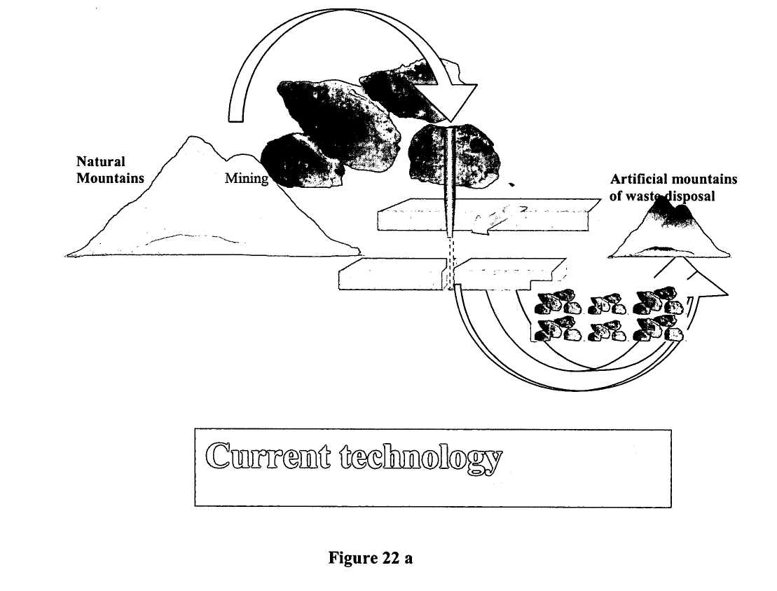

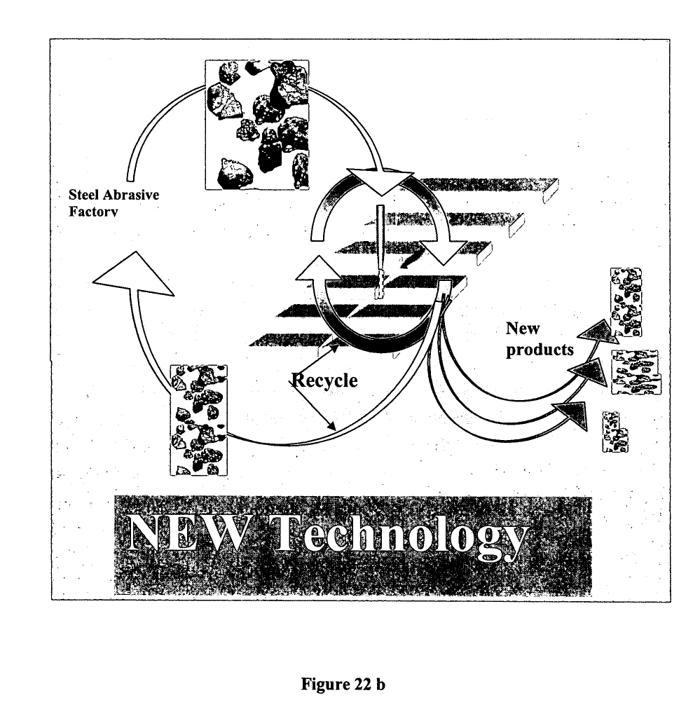

FIG. 22a depicts current abrasivejet technology as a wasteful, single function technology, compared to 22b, being a waste-free and multi-functional technology.

In summary, use of heavier abrasive particles such as stainless steel material with higher fracture toughness compared to garnet allow for lower overall costs through optimization of the entire Particle Jet process and allow for additional benefits for nano-technology that garnet or other conventional abrasives cannot achieve. Often times, through the use of select particles, both improvements to the Particle Jet cutting process and additional benefits, such as production of nano powders or nano-structuring of materials, can be achieved at the same time allowing for Particle Jet to become a highly productive and efficient technology.

It will thus be seen that the objects set forth above, among those made apparent from the preceding description, are efficiently attained and, since certain changes may be made in the above construction without departing from the spirit and scope of the invention, it is intended that all matter contained in the above description or shown in the accompanying drawings, shall be interpreted as illustrative and not in a limiting sense. It is also to be understood that the following claims are intended to cover all the generic and specific features of the invention herein described, and all statements of the scope of the invention which, as a matter of language, might be said to fall therebetween.

What is claimed is:

1. A method for processing metals and materials consisting predominantly of metallic elements by tuning a multifunctional high-pressure particle jet to optimize performance of selected tasks such as producing powders, cutting subject materials and performing surface treatment on particles and subject materials, which process comprises:
A) selecting a metallic particle and a metallic subject material to be processed;
B) providing a pressurized stream and entraining said metallic particles to form a particle jet to impact upon said metallic subject material;
C) selecting a pressure and flow rate for said pressurized stream;
D) selecting an incident angle of impact of said pressurized stream relative to said metallic subject matter;
E) impacting said particle jet into said metallic subject material; and
F) performing at least one selected task.

2. A method according to claim 1 wherein the selected pressure for said pressurized stream is in the range of about 10,000 psi to 150,000 psi at a flow rate in the range of about 0.1 GPM to 20 GPM;
the selected incident angle of impact of said pressurized stream is in the range of about 5 to 90 degrees relative to said metallic subject matter;
the selected said metallic particles have a selected hardness in the range of about 1.0 to 2.5 with respect to the hardness of said selected metallic subject material;
wherein selected task is to conduct cutting of said metallic subject material.

3. A method according to claim 1 wherein the selected pressure for said pressurized stream is in the range of about 10,000 psi to 150,000 psi at a flow rate in the range of about 0.1 GPM to 20 GPM;
the selected incident angle of impact of said pressurized stream is in the range of about 5 to 90 degrees relative to said metallic subject matter;
the selected said metallic particles have a selected hardness in the range of about 0.05 to 1.5 with respect to the hardness of said selected metallic subject material;
wherein selected task is to conduct surface treatment of said subject material.

4. A method according to claim 3 wherein said particles are spherically shaped particles.

5. A method according to claim 1 wherein said metallic particles are comprised of at least 51% of total composition by weight of metal elements and said metallic subject matter is comprised of at least 51% of total composition by weight of metal elements.

6. A method according to claim 1 wherein said metallic particles are comprised of the substantially the same metal elements as said metallic subject material;

7. A method according to claim 2 wherein the process further comprises:
fracturing particles by impacting said metallic particles into a metallic subject material to create smaller particles; and
capturing said smaller particles for use in non-particle jet applications or further particle jet applications.

8. A method according to claim 7 wherein said non-particle jet applications include powdered materials, coatings, claddings, polishing wheels or discs, grinding wheels or discs, injection moldings, or bonded substrates.

9. A method for surface treating metals and materials consisting predominantly of metallic elements by the use of high-pressure particle jet, which process comprises:
A) providing a pressurized stream and entraining metallic particles to form a particle jet to impact upon a metallic subject material;
B) selecting a pressure and flow rate for said pressurized stream;
C) selecting an incident angle of impact of said particle jet relative to said metallic subject matter;
D) selecting a hardenable metallic material for said metallic subject matter or said metallic particles;
E) impacting said particle jet into said metallic subject material;
H) performing a selected task of surface treating a selected material; and
F) capturing said metallic particles and repeating step E; or
G) capturing said metallic particles for non-particle jet applications.

10. A method according to claim 9 wherein the selected pressure for said pressurized stream is in the range of about 10,000 psi to 150,000 psi at a flow rate in the range of about 0.1 GPM to 20 GPM;
the selected incident angle of impact of said particle jet is in the range of about 5 to 90 degrees relative to said metallic subject matter;
wherein said metallic subject material is the selected hardenable material; and
wherein selected task is to conduct surface treatment of said metallic subject material.

11. A method according to claim 10 wherein said metallic particles are spherically shaped particles.

12. A method according to claim 9 wherein the selected pressure for said pressurized stream is in the range of about 10,000 psi to 150,000 psi at a flow rate in the range of about 0.1 GPM to 20 GPM;
the selected incident angle of impact of said particle jet is in the range of about 5 to 90 degrees relative to said metallic subject matter; wherein said metallic particles is the selected hardenable material; and
wherein selected task is to conduct surface treatment of said metallic particles.

13. A method for material separation of metals and materials consisting predominantly of metallic elements by the use of high-pressure particle jet, which process comprises:
A) providing a pressurized stream and entraining metallic particles to form a particle jet to impact upon a metallic subject material;
B) selecting a pressure and flow rate for said pressurized stream;
C) selecting an incident angle of impact of said particle jet relative to said metallic subject matter;
D) selecting a metallic material for said metallic subject matter or said metallic particles;
E) impacting said particle jet into said metallic subject material;
F) performing a selected task of material separation of a selected material; and
G) capturing said metallic particles and repeating step E; or
H) capturing said metallic particles for non-particle jet applications.

14. A method according to claim 13 wherein wherein the selected pressure for said pressurized stream is in the range of about 10,000 psi to 150,000 psi at a flow rate in the range of about 0.1 GPM to 20 GPM;
the selected incident angle of impact of said pressurized stream is in the range of about 5 to 90 degrees relative to said metallic subject matter;
the selected relative hardness of said metallic particles is the range of about 1.0 to 2.5 with respect to the hardness of said metallic subject material and of said metallic particles relative to each other;
wherein selected task is to conduct cutting of said metallic subject material.

15. A method according to claim 13 wherein wherein the selected pressure for said pressurized stream is in the range of about 10,000 psi to 150,000 psi at a flow rate in the range of about 0.1 GPM to 20 GPM;
the selected incident angle of impact of said pressurized stream is in the range of about 5 to 90 degrees relative to said metallic subject matter;
wherein selected task is to create powders from material separation of said metallic particles and said metallic subject material.

16. A method according to claim 1 wherein said metallic particles are selected from the group consisting of aluminum alloy, iron, copper alloy, steel, stainless steel, titanium alloy, high temperature alloy or chromium-nickel alloy.
